(19) United States
(12) Patent Application Publication
(10) Pub. No.: US 2024/0408521 A1
(43) Pub. Date: Dec. 12, 2024

(54) ARTICLE FOR FILTERING USING POROUS POLYMERIC MATRIX

(71) Applicant: Stephen James Grunzinger, Stillwater, MN (US)

(72) Inventor: Stephen James Grunzinger, Stillwater, MN (US)

(21) Appl. No.: 18/370,791

(22) Filed: Sep. 20, 2023

Related U.S. Application Data
(60) Provisional application No. 63/408,812, filed on Sep. 21, 2022.

(51) Int. Cl. B01D 39/16; B01D 46/00; B01D 46/30

(52) U.S. Cl. CPC B01D 39/16; B01D 46/0036; B01D 46/30; B01D 2239/0407; B01D 2239/1216; B01D 2239/1241; B01D 2279/50

(57) ABSTRACT

A filter article and use thereof where the filter article contains a porous polymeric matrix with a pore and a channel nominal size of about 100 microns to about 1 nm in the form of an isotropic bicontinuous phase channel structure to remove contaminants such as PM2.5 particles from a fluid stream when the fluid stream passes and comes into contact with the filter article.

### PRIORITY CLAIM

This application claims priority to U.S. Provisional Application No. 63/408,812, filed Sep. 21, 2022, the content of the application is hereby incorporated by reference.

### FIELD OF THE INVENTION

The present invention relates to an article for filtering that is a porous polymeric matrix and optionally a plurality of a sorption particle. The article is for removing particles, chemical compounds, chemical ions, or chemical components from gas and fluid streams. The porous polymer matrix is a durable material comprising polyvinyl chloride or chlorinated polyvinyl chloride capable of removing contaminants and of having a flow rate of gas or fluids through its structure resulting from a bicontinuous structure.

### BACKGROUND OF THE INVENTION

Filters are often a choice for removing contaminants from a fluid stream such as air or water. It is difficult to re-use or clean filters made from paper or cellulose-based materials. It is desired to have a durable filter capable of interaction with gasses or liquids with good flow that can be cleaned and reused while maintaining its filtering properties.

Specific uses of these filters are for removing contaminants from gas and fluid streams such as smoke from fires and air pollution.

There continues to be a desire to provide functional filter materials that remove undesired ions, chemicals, and compounds from the gas or fluid streams that can be easily cleaned and reused without a decrease in performance.

There also remains the need for filters with good airflow while removing desired levels and sizes of contaminants.

### SUMMARY OF THE INVENTION

The present invention relates to the use of a filter article to remove contaminants from a gas or fluid stream comprising the steps of directing a contaminated gas or fluid stream into contact with the filter article, contacting the contaminated stream with the filter article for a period of time to result in a modified stream, wherein the modified stream comprises a second concentration of contaminants, wherein the second concentration of contaminants is less than the first concentration of contaminants, the filter article comprising a supporting frame and a filtering media, the filtering media contained within the frame, the filtering media further comprising a microporous polymeric matrix wherein the microporous polymeric matrix comprises a pore and a channel nominal size of about 100 microns to about 1 nm.

The present invention further relates to a filter article comprising a supporting frame and a filtering media, the filtering media contained within the frame, the filtering media further comprising a microporous polymeric matrix wherein the microporous polymeric matrix comprises a pore and a channel nominal size of about 100 microns to about 1 nm.

### BRIEF DESCRIPTION OF THE DRAWINGS

The present invention shall be further described with reference to the accompanying drawings in which:

FIG. 1 is a perspective view of a supporting frame with an open structure for the face area in proximity with an air movement source.

FIG. 2 is a perspective view of a supporting frame with an open structure suitable for use in an HVAC system.

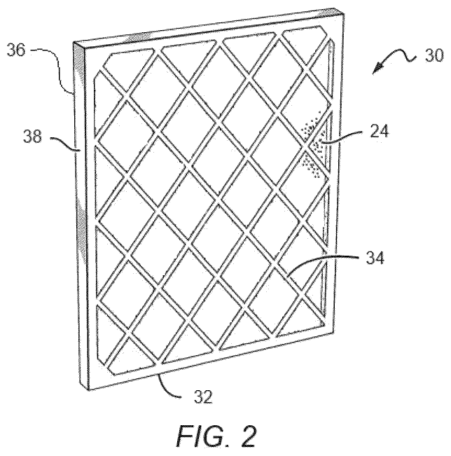

### DETAILED DESCRIPTION OF THE INVENTION

The present invention relates to a filter article and methods of using the same. The present invention relates to a filter article comprising a porous polymeric matrix and an air movement source, the matrix comprising a polyvinyl chloride or chlorinated polyvinyl chloride polymer.

The present invention relates to a filtering process comprising the step of contacting a gas or fluid stream comprising one or more contaminants with an article comprising a porous polymeric matrix and air movement source, the matrix comprising a polyvinyl chloride or chlorinated polyvinyl chloride polymer.

A fluid movement source may be selected from a device that creates movement in the air or fluid, such as a motorized fan, blower, or pump. One air movement source may be a blower or fan operated by a DC brushless motor. The fan, blower, or pump selection may be suitable for air movement, such as in an indoor environment, to provide an airflow rate to bring a volume of gas or fluid with contaminates into contact with the porous polymeric matrix. One suitable example is a blower comprising a 12V 1 A motor with a 120 mm fan with a 2.1 mm barrel plug to connect to a power source. Any power source that can supply from 3 to 12V with an appropriate 2.1 mm barrel plug can be utilized. Other air movement sources may be a heating, ventilation, and air conditioning (HVAC) system which provides forced air sources for the supply or return air coming into contact with the matrix.

The present invention relates to a filter article comprising a porous polymeric matrix, the matrix comprising a polyvinyl chloride or chlorinated polyvinyl chloride polymer. The porous polymeric matrix may be in a pellet form, a sheet form, or a three-dimensional structure in the fluid stream comprising one or more contaminants that may come into contact. The porous polymeric matrix comprises pellets having an average diameter of 1 mm or less, preferably 0.5 mm or less. A pellet bed will allow air to move relatively quickly and capture pollutants in the pores of the porous polymeric matrix.

The porous polymeric matrix may be held within a supporting frame, the supporting frame having a volume. The supporting frame has an open structure allowing for the fluid stream to come into contact with the porous polymeric matrix. The supporting frame is configured to engage with a device or a holder where air is forced through the porous polymeric matrix by an air movement source. The supporting frame comprises a face area where a contaminated gas or fluid stream can come into contact with the porous polymeric matrix and then pass through the porous polymeric matrix. The face area may comprise a material that is capable of a fluid stream traveling through such as a mesh from a metal, fiber, or polymeric material. The supporting frame forms a volume into which the porous polymeric matrix may be contained or held.

In one embodiment, the supporting frame is a cylinder comprising a sidewall, a base wall, and a top wall, the cylinder at least partially comprising a face area located in the sidewall or the base wall. The face area preferably located in the base wall and the portion of the sidewall located tangential to the base wall. The cylinder having a height, the height can be the same as the height of the porous polymeric matrix, such as if the porous polymeric matrix is a pellet bed having a bed height.

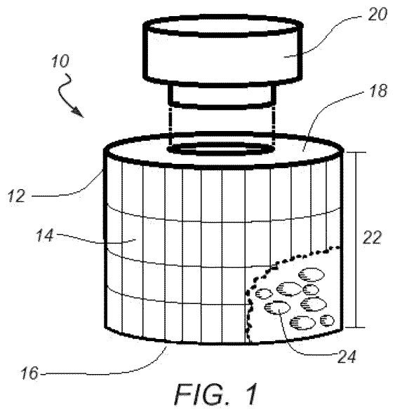

FIG. 1 shows an expanded view of a filter article (10) comprising a supporting frame (12) in the shape of a cylinder and a blower (20). The supporting frame (12) comprising a sidewall (14), a base wall (16), and a top wall (18). The supporting frame (12) has a height (22) resulting in a volume, the volume contains the porous polymer matrix (24).

In one embodiment, the filter article (30) comprises a supporting frame (32). The support frame (32) comprises a face area on a first side (34) and a face area on a second side (36). The supporting frame further comprises a thickness (38) between the face areas. The thickness (38) in the volume contains the porous polymer matrix (24).

The porous polymeric matrix may be a pellet bed that is held within the supporting frame. A removable cartridge or a plurality of removable cartridges containing the porous polymeric matrix may be detachably connected from the supporting frame may be used. A removable cartridge can be detached from the support frame in order to clean the porous polymeric matrix from time-to-time. The ability to clean the porous polymeric matrix allows for re-use and longer term use of the filter article. The removable cartridge may comprise a material that is capable of a fluid stream traveling through such as a mesh from a metal, fiber, or polymeric material. The removable cartridge forms a volume into which the porous polymeric matrix may be contained or held.

The filter article is used to remove undesired materials from a gas or fluid stream when a contaminated gas or fluid stream is directed (directed stream) to come into contact with the article and the porous polymeric matrix within the article. The contaminated stream after contact with the filter article is converted into a modified stream, where the modified stream comprises a second concentration of contaminants, further wherein the second concentration of contaminants is less than the first concentration of contaminants.

The contaminated fluid stream comprises contaminates in a first concentration. The contaminants of such streams may include particulates, such as PM2.5, and VOC air pollution. The contaminated fluid stream is moved by an air movement source into contact with the article comprising a porous polymeric matrix, such that a second level of contaminants is obtained in such a modified stream. The second level of contaminants should be maintained during the duration of use in the article without a significant reduction of flow rate or airflow rate.

The flow rate or airflow rate of the stream when contacting the article comprising a porous polymeric matrix should be less than 25% versus airflow without a filter present, such as less than 20%, such as less than 15%.

An optional process is to contact the porous polymeric matrix with a solvent, such as water. Exposure to water removes the contaminants from the surface and pores of the porous polymeric matrix. Preferably the porous polymer matrix is removed from the article or the air movement source. The porous polymer matrix after contacting water is then dried and combined with the air movement source or the article. Agents such as surfactants, solvents, or similar materials may be used in combination with water to contact the porous polymeric matrix.

Once replaced into the air movement source or the article, the second level of contaminants should be maintained during the duration of use in the article. In this context, maintained means that the reduction in removal of contaminants versus a virgin (new) porous polymer matrix should be less than 50%, such as less than 40%, such as less than 30%.

The porous polymeric matrix structure results from an extracted bicontinuous structure wherein the porous polymer matrix polymer is mixed with a water-soluble polymer to form a bicontinuous structure. The water-soluble polymer can be removed from the bicontinuous structure, leaving the porous polymer matrix. The porous polymer matrix is isotropically porous through microchannels in vertical and horizontal directions. The bicontinuous phase structure has two distinct phases (a porous polymer matrix polymer and a water-soluble polymer), where each phase has an uninterrupted pathway through the entire volume of the material. If the first phase, the porous polymer matrix polymer, is interrupted, the material will fall apart when placed in water. If the second phase, the water-soluble polymer phase, is interrupted, the material will not be gas or fluid-permeable. The combination of structural stability and the ability for gas or fluids to diffuse through the porous polymer matrix indicates a bicontinuous phase structure. The bicontinuous phase structure is isotropic in both the vertical and horizontal directions. The structure is random and does not orient in any particular direction.

Other suitable co-continuous structures include interconnected circular domain structures or interconnected elliptical domain structures of the second phase (minor component) in the first phase (major component). Lamellae structures are suitable should the resulting co-continuous phase structure allow for the first phase to have an interconnected structure and the second phase to have an interconnected structure.

The porous polymer matrix comprises one or more materials, including, but not limited to, polyvinyl chloride, chlorinated polyvinyl chloride, or acrylonitrile butadiene styrene (ABS). The materials used for the porous polymer matrix have a first processing temperature. Polyvinyl chloride has a reported melting point of 212 deg F. to 500 deg F. (100 deg C. to 260 deg C.), which would be equal to or less than the processing temperature. K values have been used to describe polyvinyl chloride. Suitable K values may be selected from about 35 and about 80, such as about 50 to about 80, such as about 60 to about 75. Chlorinated polyvinyl chloride may have a processing temperature from about 180 to about 200 deg C. The K value of chlorinated polyvinyl chloride may be between about 50 and about 70, such as about 53 to about 55, and the chlorine content may be between about 60 and about 70%, such as about 66% to about 68%. The use of chlorinated polyvinyl chloride may require the further use of stabilizers and lubricants, such as montan wax, for processability purposes.

The porous polymer matrix has a porous structure that is a network of interconnected channels within the polymer matrix. The pore and channel nominal sizes are 100 microns or less, preferably 100 microns to 10 nanometers. The channels and pores are robust, mechanically, and chemically stable.

### Nominal Pore Size Determination Method

Typically, nominal pore sizes may be determined by TEM (Transmission Electron Microscope) or Raman spectroscopy, although other methods are known in the art. For purposes of the present nominal pore sizes, TEM is used. The pore size (or width) is referred to as the smallest dimension within a given pore shape, that is, the diameter for a cylindrical pore and, for irregular pores, the smallest distance.

Porosity (ε) is between about 10% and about 80%, such as 10%, 15%, 20%, 25%, 30%, 35%, 40%, 45%, 50%, 55% 60%, 65%, 70%, 75% and 80%. In some embodiments, porosity is between 10% and 35%, such as 10% and 20%. In some embodiments, porosity is between 20% and 30%. In some embodiments, porosity is between 15% and 35%. For a single-phase material, such as the porous polymer matrix, the value of Vᵥ can be obtained from the difference between the volume of the solid (computed from its lattice density) and the apparent total bulk volume (V_{T}) of the sample:

$$( ε ) = Vv / Vt$$

### The Flow Rate of an Article

The nominal pore size of the porous polymer matrix or the porosity of the porous polymer matrix should be such that a low rate of deionized water through the porous polymer matrix is between 0.01 and 0.5 (mL/min)/in2, such as 0.01-0.05 (ml/min)/in2, such as 0.1-0.5 (mL/min)/in2. Flow rate is measured with a sample size of ⅛ inch in thickness and ⅞ inches in diameter; the fluid used for the flow rate is deionized water, delivered at a fluid pressure of 1 psi.

The formation of pores (2-dimensional aspect) or channels (3-dimensional aspect) in the article is a result of a bicontinuous network formed by the polymer, such as polyvinyl chloride or chlorinated polyvinyl chloride, and a second polymer. The bicontinuous phase structure is isotropic in both the vertical and horizontal directions. The structure is random and does not orient in any particular direction. The second polymer is selected to be water soluble, such as polyethylene glycol, polyethylene oxide, or polyvinyl alcohol. The second polymer has a second melting point between about 40 deg C. to about 70 deg. C. For example, polyethylene oxide having an average weight average molecular weight of 100,000 has a melting point between about 65 deg C. to about 75 deg. C. Polyethylene oxide with an average weight average molecular weight of about 200,000 has a melting point of about 63 deg C. to about 66 deg C. Polyethylene oxide with an average weight average molecular weight of 8000 has a melting point between about 60 deg C. to about 63 deg C. Polyethylene oxide with an average weight average molecular weight of 6000 has a melting point between about 58 deg C. to about 62 deg. C. Polyethylene oxide with an average weight average molecular weight of 3000 has a melting point between about 50 deg C. to about 60 deg. C.

Polyethylene oxide should have an average weight average molecular weight of more than 61, such as above 100, such as above 500, such as above 600, such as above 1000, such as about 3000, such as about 8000. The polyethylene oxide molecular weight should be less than 200,000, such as less than 150,000, such as less than 100,000, such as less than 80,000. The polyethylene oxide molecular weight is selected from between about 1000 to about 100,000, such as about 1000 to 6000, such as about 1000 to about 5000, such as about 6000 to 10,000, such as about 10,000 to 50,000.

The nominal pore sizes and nominal channel sizes will be dependent upon the selection of the water-soluble polymer used to form the article. The second polymer, which is water soluble, is used to create a bicontinuous structure with the polymer matrix material. The article is formed when the polymer matrix material and a second polymer are heated to above both the first melting point (polymer matrix material melting point) and the second melting point (the second polymer) to form a melt, then the melt is mixed to form a polymeric mixture and then allowed to cool below both the first melting point and the second melting point. Upon cooling, the polymeric mixture phase separates via spinodal decomposition and forms a bicontinuous network that is isotropically porous when the water-soluble polymer is extracted.

The present invention relates to a method of filtering by using a plurality of pellets comprising a bicontinuous structure of polyvinyl chloride or chlorinated polyvinyl chloride and a polyethylene oxide polymer, the polyethylene oxide polymer having an average weight average molecular weight less than 100,000, wherein the bicontinuous structure comprises a nominal channel size of polyethylene oxide polymer between 100 microns and 1 nm, the article may optionally comprise a plurality of sorption particles, the sorption particles are distributed in the polyethylene oxide polymer, and the nominal sorption particle size is selected to be less than the nominal channel size. The polyethylene oxide polymer is selected to have an average weight average molecular weight less than 100,000, such as between about 1000 to about 100,000, such as about 1000 to 6000, such as about 1000 to about 5000, such as about 6000 to 10,000, such as about 10,000 to 100,000.

The water-soluble polymer may be present from 0.01 wt % to 90 wt % by weight of the co-continuous structures before any exposure to any water, such as 0.01 wt % to 50 wt %, such as from 0.01 wt % to 30 wt %, such as 5 wt % to 30 wt %, such as 10 wt % to 30 wt %, such as 15 wt %, 20 wt %, 25 wt % and 30 wt %.

Micropores form in the bicontinuous structure through the removal of the water-soluble polymer. The water-soluble polymer may be extracted warm water bath (more than 50 deg C., preferably more than 60 deg C., such as about 60 deg C. to about 80 deg C., such as about 70 deg C., or through the application of steam to the bicontinuous structure. The water-soluble polymer crystallites to melt at the increased temperature, allowing the water-soluble to flow out of the polymer matrix.

If water cannot be used, isopropanol or hexane may be used for the extraction step. The polymer matrix material does have a solvent resistivity toward both of these solvents, and the microstructure should not be impacted by either.

The porous polymeric matrix is used for filtration in the form of a plurality of pellets, the plurality of pellets forming a pellet bed with a height or thickness. The plurality of pellets may be approximately the same shape and size or may be a mixture of various shapes or various sizes. The pellet size may be from 1 mm to 20 mm in the largest dimension. The pellet can have a three-dimensional shape where the smallest dimension is greater than 0.01 mm, such as 1.6 mm or 3.175 mm, or more. The pellet can have a uniform surface or a non-uniform surface, including positive and negative texture, including embossing or structures extending from the article surface. The pellet may have a shape selected from spherical, oval, capsule, tube, rectangular, disk or more complex shapes. The pellet size may comprise a distribution of sizes from 1 mm to 20 mm in the largest dimension. The volume of pellets is selected to achieve the best filtration results while maintaining the desired air flow rates through the volume of pellets. The supporting frame comprises a thickness that contains the volume of pellets.

The pellet bed height provides the dwell time of a gas or fluid stream comprising one or more contaminants. The pellets themselves provide mixing and slowing of the contaminates and the surface area provided by the porosity of the porous polymeric matrix further provides surface area for the interaction and removal of contaminants from the gas or fluid stream. The specific height of the pellet bed is dependent upon the volume of the supporting frame or a removable cartridge in which the pellet bed is contained. The minimum height is selected to be sufficient to achieve desired removal of the contaminants. The maximum height is selected to maintain a desired airflow rate through the pellet bed.

The plurality of pellets may be contained in a compartment that is permeable or semipermeable to a gas or fluid stream comprising one or more contaminants. One embodiment is the porous polymeric matrix pellet bed contained in a supporting frame comprising a housing, air inlet ports, retaining screens above and below the pellets, and a blower fan. The housing and screens comprise a cartridge to prevent the pellets from spilling or being sucked out while channeling the air through the pellets. The air movement source, such as a blower fan, provides the airflow with enough pressure to pull air through the pellets.

One embodiment is the porous polymeric matrix pellet bed contained in one or more removable cartridge that is held within the supporting frame that is placed within an HVAC system.

### EXAMPLES

A testing chamber is roughly 333 ft³. The testing chamber comprises a frame made of PVC plumbing pipe (96″ L×63″ W×98″ H) and plastic sheets with an access door. Power was run into the testing chamber by power cords through the wall of the testing chamber. All seams were sealed with foil tape. Inside the testing chamber, an air sensor (PurpleAir Model PA-1) was placed on the floor (sensor height=0) or placed on a support 4 feet from the floor in the center (sensor height=4). A filter article comprising a pellet bed of the porous polymeric matrix consisting of a housing, air inlet ports, retaining screens above and below the pellets, and a blower fan was used. The housing and screens prevent the pellets from spilling or being sucked out while channeling the air through the pellets. The blower fan provides the airflow with enough pressure to pull air through the pellets. The filter article was typically placed on the floor and directed toward the center of the testing chamber. The test ‘air pollutant’ was ˜½ teaspoon of a commercially available drywall mudding compound blown into the testing chamber from a ½″ PVC pipe with a window screen filter on the dispensing end, placed through the wall of the testing chamber. The drywall mudding compound was blown into the testing chamber using compressed air. The prototype blower was powered on after the air sensor registered a reading of over 150.

TABLE 1

| | | | | PM2.5 | PM2.5 | PM2.5 | | Raw | Raw |
|---|---|---|---|---|---|---|---|---|---|
| | Bed | Stack | | 150 to | 150 to | 60 min | Sensor | PM1.0 | PM10.0 |
| | Height | Diameter | Pellet | 75 | 30 | Reduction | Height | Reduction | Reduction |
| Example | (mm) | (in) | CFM* | (min) | (min) | (%) | (ft) | (%) | (%) |
| 1 | 0 | 6 | 11.2 | 120.2 | 432.2 | 36.0 | 4 | 31.4 | 43.9 |
| comparative | | | | | | | | | |
| 2 | 0 | 6 | 23.7 | 119.1 | 364.7 | 32.8 | 4 | 27.7 | 41.7 |
| comparative | | | | | | | | | |
| 3 | 70 | 6 | 14.3 | 64.2 | 188.3 | 50.4 | 4 | 43.5 | 57.8 |
| 4 | 70 | 6 | 24.4 | 17.2 | 71.8 | 74.7 | 4 | 70.8 | 82.6 |
| 5 | 90 | 6 | 0.0 | 233.7 | 995.8 | 20.0 | 4 | 15.5 | 23.1 |
| comparative | | | | | | | | | |
| 6 | 90 | 6 | 11.5 | 73.5 | 220.0 | 44.7 | 4 | 39.8 | 50.2 |
| comparative | | | | | | | | | |
| 7 | 90 | 6 | 14.3 | 46.7 | 166.0 | 55.9 | 4 | 50.1 | 62.8 |
| 8 | 90 | 6 | 24.1 | 26.5 | 98.9 | 68.9 | 4 | 62.8 | 77.4 |
| 9 | 90 | 6 | 24.4 | 36.8 | 106.1 | 64.9 | 4 | 59.4 | 72.7 |
| 10 | 100 | 6 | 18.8 | 38.6 | 114.6 | 64.0 | 4 | 60.1 | 69.3 |
| 11 | 100 | 6 | 23.0 | 39.0 | 146.1 | 59.7 | 4 | 51.7 | 68.8 |
| 12 | 100 | 6 | 24.4 | 30.9 | 104.3 | 67.4 | 4 | 64.0 | 75.8 |

*cubic feet per minute measured by a handheld digital anemometer held next to the exiting surface of the pellet bed.

A reduction of the test pollutant PM2.5, PM1.0, and PM10.0 was consistently achieved compared to the same device without the porous polymeric matrix pellet bed when the bed was 70-100 mm in height (6″ (152.4 mm) diameter). Results were calculated by first shifting time zero to 150 PM2.5 of the raw data (not the AQI reading).

The porous polymeric matrix may further comprise a sorption particle. The average particle size of the sorption particle is between about 100 microns to about 10 nanometers. As used herein, ‘particle’ may encompass particles with a single dimension in the range of 100 microns to about 10 nanometers or it can have all dimensions in the range of 100 microns to about 10 nanometers. Particles may have an irregular but generally spherical shape or a nanosheet shape with two dimensions greater than the 100 microns to 10 nanometer range, or a nanotube shape with one dimension greater than the 100 microns to 10 nanometer range. For example, an individual graphene nanosheet, or stack of graphene nanosheets, can have a thickness dimension of about 0.4 to about 1 nm. Select the average particle size as the size or slightly larger than the nominal channel size of the porous polymer matrix. The sorption particle has a surface area. The surface area of the sorption particle is located in the porous polymer matrix channel or within the polyethylene oxide channel of the bicontinuous structure of the article.

The sorption particle is present in the article in an effective amount. The sorption particle may be present in an amount of 100 PHR or less with respect to the PVC polymer, such as from 1 PHR to 60 PHR, such as 1 PHR to 50 PHR, such as 10 PHR to 50 PHR, such as 20 PHR to 60 PHR, such as 20 PHR to 40 PHR, such as 20 PHR to 30 PHR, such as less than 60 PHR, such as 55 PHR, 50 PHR, 45 PHR, 40 PHR, 35 PHR, 30 PHR, 25 PHR, 20 PHR, 15 PHR, 10 PHR, 9 PHR, 8 PHR, 7 PHR, 6 PHR, 5 PHR, 4 PHR, 3 PHR, 2 PHR, and 1 PHR. The sorption particle may be present in a weight percentage relative to the water-soluble polymer, such as the PEO. The weight percentage of the sorption particle present relative to the water-soluble polymer is from 0.01 to 50 wt %, Such as 1 to 30 wt %, such as 5 to 10 wt %, such as 20 to 50 wt %, such as 1 to 10 wt %.

Sorption particles may be selected as the same material or a mixture of materials. For example, a mixture of two or more materials may be selected as the sorption particles, such as two different materials, such as three different materials, or such as four different materials or more.

Suitable sorption particles include metal oxides and hydroxides such as magnesium oxide, manganese oxide (MnO2, Mn2O3, Mn3O4) and manganese hydroxide (Mn(OH)4), iron oxide, copper oxide, zinc oxide, zirconium oxide, and aluminum oxide. Mixtures of metal oxides are also possible.

Silica or silicon dioxide may also be selected as a suitable sorption particle. Montmorillonite Clay, zeolites, calcium oxide, and calcium sulfate may also be suitable desiccant sorption particles.

Known adsorbing materials such as activated carbon, graphene, and boron nitride are also suitable as sorption particles. Suitable sorption particles include absorption particles such as metal organic framework materials. Suitable metal-organic framework materials include zirconium propoxide Zr(nPrO)4, zirconium carbonic acid and Basolite C300, MOF-808 (or the equivalent by in situ formation by addition of Zr(nPrO)4, tricarboxybenzene (a.k.a., trimesic acid), and NaOH as an acid scavenger), and MOF-5 (or the equivalent by in situ formation adding Zn(NO3)2, terephthalic acid, and NaOH as an acid scavenger) and Zn-MOF-74 (or the equivalent by in situ formation is proposed by adding Zn(NO3)2 and 2,5-dihydroxyterephthalic acid, and NaOH as an acid scavenger).

Nanogalvanic particles (NGP) discussed in US20190024216, “Aluminum Based Nanogalvanic Alloys for Hydrogen Generation,” which is incorporated by reference including the examples, discusses aluminum-based alloys which generate hydrogen very rapidly by reaction with water at room temperature. The aluminum alloys may be composed of primarily aluminum and other metals such as tin, magnesium, silicon, bismuth, lead, gallium, indium, zinc, carbon, or similar multivalent metal ions and mixtures thereof. The aluminum alloy forms the anode of a galvanic cell. It is coupled with another metal acting as the cathode, such as tin, magnesium, silicon, bismuth, lead, gallium, indium, zinc, carbon, or similar multivalent metal ions and mixtures thereof. The galvanic cell is formed by the aluminum alloy anode and the selected cathode, each of which is selected to have different corrosion potentials. The powder is prepared by ball milling at cryogenic temperatures rendering the material to a powder size of 50 to 100 microns. When mixed with a moisture source, the NGP produces a rapid production of hydrogen and is consumed in a relatively short duration of time (less than 10 minutes).

Suitable sorption particles include buffering materials to keep the pH in the desired pH range. Suitable buffering materials may include calcium carbonate; sodium bicarbonate; calcium phosphates; tricalcium phosphate carbonated calcium phosphates; magnesium hydroxide, sodium hydroxide, potassium hydroxide and/or lithium hydroxide; citric acid, oxalic acid, tartaric acid, phtalic acid, acetic acid, benzoic acid, glutaric acid, adipic acid (such as calcium hydroxyapatite or carbonated apatite), and carbonic acid and mixtures thereof.

Suitable sorption particles include chelants, such as alkylenepolyamine polyacetic acids and their salts, such as EDTA. The chelant would include a sufficient quantity of sodium, potassium, or calcium sulfide to remove heavy metal ions such as iron, copper, nickel, chromium, lead, and zinc ions.

Suitable sorption particles include catalysts such as homogeneous and heterogeneous catalysts; these catalysts may include ruthenium, ruthenium oxide, palladium, palladium oxide, platinum, platinum oxide, cerates, manganates, mauganites, chromates, chromites, or vanadates of cobalt, nickel, cerium, iron, manganese, chromium, copper, zinc, bismuth, silver, rare earths, molybdenum, tungsten, tin, arsenic and antimony; and mangano-chromia-manganites.

Once the composition is made, it can be extruded or injection molded into any desired shape, such as having a shape where the smallest dimension is greater than 0.01 mm, such as 1.6 mm or 3.175 mm. The article can then be exposed to water to remove the PEO from the porous polymeric matrix but leave the sorption particle trapped within the channels of the porous polymeric matrix.

The article may comprise filler materials, stabilizers such as ascorbic acid, and colorants. The article may be essentially free of surfactants. The article may be essentially free of solvents. The article may be essentially free of plasticizers. The article can have a three-dimensional shape where the smallest dimension is greater than 0.01 mm, such as 1.6 mm or 3.175 mm, or more. The article can have a uniform surface or a non-uniform surface, including positive and negative texture, including embossing or structures extending from the article surface.

The article can be used as part of a process where an undesired material is removed from a stream when the stream passes through the article according to any embodiment herein. The process includes contacting a stream containing a first concentration of an undesired material with at least a portion of the article; the stream is converted into a modified stream where the modified stream comprises a second concentration of an undesired material, wherein the second concentration of an undesired material is less than the first concentration of an undesired material.

Including sorption particles in the formation of the microporous polymeric structure can provide exposure of an effective amount of sorption particles to the gas or liquid streams containing undesired materials for removal while still keeping the sorption particles located in a static position within the microporous polymeric structure. The selection of the sorption particle is dependent upon the ion, compound, or chemical desired to be removed (undesired material) and the best mechanism for removing the undesired material such as ion exchange, chemisorption, physisorption, chelation, or catalysis.

1. Use of a filter article to remove contaminants from a gas or fluid stream comprising the steps of directing a contaminated gas or fluid stream into contact with the filter article, contacting the contaminated stream with the filtering article for a period of time to result in a modified stream, wherein the modified stream comprises a second concentration of contaminants, wherein the second concentration of contaminants is less than the first concentration of contaminants, the filter article comprising a supporting frame and a filtering media, the filtering media contained within the frame, the filtering media further comprising a microporous polymeric matrix wherein the microporous polymeric matrix comprises a pore and a channel nominal size of about 100 microns to about 1 nm.

2. A filter article comprising a supporting frame and a filtering media, the filtering media contained within the frame, the filtering media further comprising a microporous polymeric matrix wherein the microporous polymeric matrix comprises a pore and a channel nominal size of about 100 microns to about 1 nm.

3. The filter article of claim 2 wherein the microporous polymeric matrix comprises an isotropic bicontinuous phase channel structure.

4. The filter article of claim 2 wherein the microporous polymeric matrix comprises a polyvinyl chloride or chlorinated polyvinyl chloride polymer.

5. The filter article of claim 4 wherein the microporous polymeric matrix further comprises a sorption particle in an amount of 100 PHR or less with respect to the polyvinyl chloride or chlorinated polyvinyl chloride polymer.

6. The filter article of claim 5 wherein the average particle size of the sorption particle is between about 100 microns to about 10 nanometers.

7. The filter article of claim 2 wherein the filtering media comprises a plurality of pellets, the plurality of pellets forming a pellet bed comprising a height.

8. The filter article of claim 2 wherein the frame comprises a volume and a face area, the face area is in close proximity to the pellet bed.

9. The filter article of claim 8 wherein the frame further comprises a removable cartridge or a plurality of removable cartridges containing the porous polymeric matrix, wherein the cartridge is detachably connected from the supporting frame.
